(19) United States
(12) Patent Application Publication
(10) Pub. No.: US 2024/0270601 A1
(43) Pub. Date: Aug. 15, 2024

(54) METHOD FOR MANUFACTURING POSITIVE ELECTRODE ACTIVE MATERIAL, METHOD FOR MANUFACTURING LITHIUM-ION BATTERY, POSITIVE ELECTRODE ACTIVE MATERIAL, AND LITHIUM-ION BATTERY

(71) Applicant: TOYOTA JIDOSHA KABUSHIKI KAISHA, Toyota-shi (JP)

(72) Inventors: Kentaro MATSUMOTO, Toyota-shi (JP); Shohei KAWASHIMA, Susono-shi (JP); So YUBUCHI, Sunto-gun (JP); Jun YOSHIDA, Mishima-shi (JP); Satoshi WAKASUGI, Susono-shi (JP)

(73) Assignee: TOYOTA JIDOSHA KABUSHIKI KAISHA, Toyota-shi (JP)

(21) Appl. No.: 18/433,656

(22) Filed: Feb. 6, 2024

(30) Foreign Application Priority Data
Feb. 13, 2023 (JP) 2023-019891
Nov. 27, 2023 (JP) 2023-200071

(51) Int. Cl. C01G 53/00; H01M 4/505; H01M 4/525; H01M 10/052

(52) U.S. Cl. CPC C01G 53/50; H01M 4/505; H01M 4/525; H01M 10/052

(57) ABSTRACT

Disclosed is a method for increasing capacity of an O2-type positive electrode active material. The method for manufacturing a positive electrode active material of the present disclosure comprises obtaining a Na-containing transition metal oxide having a P2-type structure, substituting at least a portion of Na in the Na-containing transition metal oxide with Li by ion exchange to obtain a Li-containing transition metal oxide having an O2-type structure, and further doping the Li-containing transition metal oxide with Li in a step separate from the ion exchange.

### FIELD

The present application discloses a method for manufacturing a positive electrode active material, a method for manufacturing a lithium-ion battery, a positive electrode active material, and a lithium-ion battery.

### BACKGROUND

Positive electrode active materials having an O2-type structure (O: Octahedral) are known. A positive electrode active material having an O2-type structure can be obtained by ion exchange of at least a portion of Na in a Na-containing transition metal oxide having a P2-type structure with Li, as disclosed in PTL 1 and 2.

### CITATION LIST

### Patent Literature

[PTL 1] Japanese Unexamined Patent Publication No. 2010-092824

[PTL 2] Japanese Unexamined Patent Publication No. 2021-068556

### SUMMARY

### Technical Problem

It cannot be said that conventional positive electrode active materials having an O2-type structure have fully extracted their potential in terms of reversible capacity.

### Solution to Problem

The present application discloses the following plurality of aspects for solution to the above problem.

### Aspect 1

A method for manufacturing a positive electrode active material, the method comprising obtaining a Na-containing transition metal oxide having a P2-type structure, substituting at least a portion of Na in the Na-containing transition metal oxide with Li by ion exchange to obtain a Li-containing transition metal oxide having an O2-type structure, and further doping the Li-containing transition metal oxide with Li in a step separate from the ion exchange.

### Aspect 2

The method according to Aspect 1, wherein
the Li-containing transition metal oxide is further doped with Li in a step separate from the ion exchange by bringing a reducing solution comprising Li ions into contact with the Li-containing transition metal oxide.

### Aspect 3

The method according to Aspect 2, wherein
the reducing solution comprises an aromatic compound.

### Aspect 4

The method according to Aspect 3, wherein
the aromatic compound comprises a plurality of benzene rings.

### Aspect 5

The method according to Aspect 3 or 4, wherein
the aromatic compound comprises an electron-withdrawing group.

### Aspect 6

The method according to any of Aspects 2 to 5, wherein
the reducing solution comprises an ether.

### Aspect 7

A method for manufacturing a lithium-ion battery, the method comprising
manufacturing a positive electrode active material by the method according to any of Aspects 1 to 6,
using the positive electrode active material manufactured to obtain a positive electrode active material layer, and
using the positive electrode active material layer to obtain a lithium-ion battery.

### Aspect 8

A positive electrode active material
having an O2-type structure and
having a chemical composition represented by LiₐNa_{b}Mnₓ₋ₚNi_{y-q}Co_{z-r}M_{p+q+r}O₂, wherein 0.70<a≤1.40; 0≤b≤0.20; x+y+z=1; and 0≤p+q+r<0.17, and M is at least one element selected from B, Mg, Al, K, Ca, Ti, V, Cr, Fe, Cu, Zn, Ga, Ge, Sr, Y, Zr, Nb, Mo, and W.

### Aspect 9

The positive electrode active material according to Aspect 8, wherein
the positive electrode active material comprises 1 ppm or more of an aromatic compound.

### Aspect 10

The positive electrode active material according to Aspect 9, wherein
the aromatic compound comprises a plurality of benzene rings.

### Aspect 11

The positive electrode active material according to Aspect 9 or 10, wherein
the aromatic compound comprises an electron-withdrawing group.

### Aspect 12

The positive electrode active material according to any of Aspects 8 to 11, wherein
the positive electrode active material comprises 1 ppm or more of an ether.

### Aspect 13

A positive electrode active material,
having an O2-type structure and
comprising 1 ppm or more of an aromatic compound.

### Aspect 14

A lithium-ion battery comprising a positive electrode active material layer, an electrolyte layer, and a negative electrode active material layer, wherein
the positive electrode active material layer comprises the positive electrode active material according to any of Aspects 8 to 13.

### EFFECTS

The positive electrode active material of the present disclosure has a high capacity.

### BRIEF DESCRIPTION OF DRAWINGS

FIG. 1 shows one example of the flow of a method for manufacturing a positive electrode active material.

FIG. 2 shows one example of the flow of a method for manufacturing a lithium-ion battery.

FIG. 3 schematically shows one example of a configuration of a lithium-ion battery.

FIG. 4 shows the X-ray diffraction patterns of a positive electrode active material of Nos. 1 to 6.

### DESCRIPTION OF EMBODIMENTS

### 1. Method for Manufacturing Positive Electrode Active Material

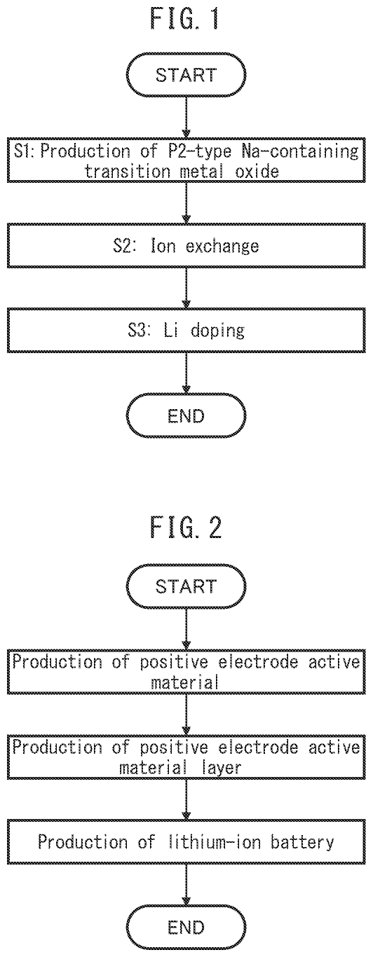

As shown in FIG. 1, a method for manufacturing a positive electrode active material according to one embodiment comprises obtaining a Na-containing transition metal oxide having a P2-type structure (step S1), substituting at least a portion of Na in the Na-containing transition metal oxide with Li by ion exchange to obtain a Li-containing transition metal oxide having an O2-type structure (step S2), and further doping the Li-containing transition metal oxide with Li in a step separate from the ion exchange (step S3).

### 1.1 Step S1

In the step S1, the Na-containing transition metal oxide having a P2-type structure can be obtained, for example, by obtaining a precursor comprising Na and a transition metal element, then optionally molding and optionally pre-firing the precursor, and subjecting the precursor to a main firing.

In the step S1, the precursor may be obtained, for example, by mixing a transition metal source and a Na source. The transition metal source, for example, may be a transition metal salt such as a carbonate, a sulfate, a nitrate, or an acetate, or may be a transition metal compound such as a transition metal hydroxide. The transition metal element may be at least one of Mn, Ni, and Co. The transition metal source may be a salt represented by Me(CO₃)ₓ (Me is at least one transition metal element among Mn, Ni, and Co, and x depends the valence of Me), may be a salt represented by Me(SO₄)ₓ, may be a salt represented by Me(NO₃)ₓ, may be a salt represented by Me(CH₃COO)ₓ, or may be a compound represented by Me(OH)ₓ. The Na source, for example, may be a Na salt such as a carbonate or a sulfate, or may be a Na compound such as sodium oxide or sodium hydroxide. The amount of the Na source mixed with the transition metal source may be determined by taking into account the amount of Na lost during subsequent firing. In the step S1, surfaces of particles composed of the above transition metal source may be coated with the Na source to obtain coated particles as the precursor. The coated particles may be obtained by coating at least a portion of the surfaces of particles composed of the above transition metal source with the Na source. The coated particles may be obtained by coating 40% by area or greater, 50% by area or greater, 60% by area or greater, or 70% by area or greater of the surfaces of particles composed of the above transition metal source with the Na source.

In the step S1, the precursor may be obtained, for example, by mixing an M source comprising an element M in addition to a transition metal source and a Na source. The element M is at least one selected from B, Mg, Al, K, Ca, Ti, V, Cr, Fe, Cu, Zn, Ga, Ge, Sr, Y, Zr, Nb, Mo, and W. By including the element M, the P2-type structure or O2-type structure can be further stabilized. The M source, for example, may be a salt such as a nitrate, a sulfate, a carbonate, or an acetate, or may be a compound other than a salt, such as a hydroxide. The amount of the M source in the precursor may be appropriately determined in accordance with the target composition of the Na-containing transition metal oxide after firing.

In the step S1, the precursor may be obtained, for example, by obtaining a precipitate using an ion source that can form a precipitation with a transition metal ion in an aqueous solution and a transition metal compound, and then mixing the precipitate with a Na source and optionally an clement M source. Examples of the ion source that can form a precipitate with a transition metal ion include sodium salts such as sodium carbonate and sodium nitrate, sodium hydroxide, and sodium oxide. Examples of the transition metal compound include salts such as nitrates, sulfates, carbonates, and acetates and hydroxides. In the step S1, the ion source and the transition metal compound may each be formed into a solution, and the solutions may then be dropped and mixed to obtain a precipitate. In this case, various sodium compounds may be used as a base, and ammonia aqueous solution may be added to adjust basicity. More specifically, in the step S1, a precipitate comprising at least one transition metal element among Mn, Ni, and Co may be obtained. The precipitate can be obtained, for example, by a solution method such as a coprecipitation method or a sol-gel method. In the case of a coprecipitation method, the precipitate is obtained, for example, by preparing an aqueous solution of Me(SO₄)ₓ and an aqueous solution of Na₂CO₃ and dropping to mix the aqueous solutions. After collecting the precipitate, the precipitate may be mixed with a Na source. The amount of the Na source to be mixed with the precipitate may be determined by taking into account the amount of Na lost during subsequent firing. In addition, surfaces of particles composed of the precipitate may be coated with the Na salt to obtain coated particles as the precursor. The coverage of the coated particles is as described above.

In the step S1, pre-firing of the precursor obtained as described above may be carried out at temperatures of main firing or less. For example, pre-firing can be carried out at a temperature of less than 700° C. The pre-firing time is not particularly limited. Alternatively, pre-firing may be omitted.

In the step S1, main firing of the precursor may be carried out at a temperature of, for example, 700° C. or higher and 1100° C. or lower, and preferably 800° C. or higher and 1000 ° C. or lower. When the main firing temperature is too low, Na doping is not carried out. When the main firing temperature is too high, O3-type structure, not P2-type structure, is easily generated. The heating conditions from the pre-firing temperature to the main firing temperature are not particularly limited. The main firing time is also not particularly limited, and for example, may be 30 min or more and 10 h or less. The main firing atmosphere is not particularly limited, and for example, may be an oxygen-containing atmosphere such as an ambient air atmosphere or an inert gas atmosphere.

In the step S1, after the above main firing, a Na-containing transition metal oxide having a P2-type structure may be doped with the above element M. Specifically, a Na-containing transition metal oxide having a P2-type structure not comprising the element M is synthesized, and then the oxide may be doped with the element M. The doping with the element M may be carried out, for example, by ion exchange.

The Na-containing transition metal oxide obtained by the step S1, for example, may comprise at least one element among Mn, Ni, and Co; Na; and O as constituent elements. Particularly, when at least Na, Mn, at least one of Ni and Co, and O are included as constituent elements, especially when at least Na, Mn, Ni, Co, and O are included as constituent elements, performance of the positive electrode active material tends to be even higher. More specifically, the Na-containing transition metal oxide obtained by the step SI may have a chemical composition represented by Na_{c}Mnₓ₋ₚNi_{y-q}Co_{z-r}M_{p+q+r}O₂ (where 0<c≤1.00; x+y+z=1; and 0≤p+q+r<0.17, and the element M is at least one selected from B, Mg, Al, K, Ca, Ti, V, Cr, Fe, Cu, Zn, Ga, Ge, Sr, Y, Zr, Nb, Mo, and W). When the Na-containing transition metal oxide has such a chemical composition, a P2-type structure is easily maintained. In the above chemical composition, c may be greater than 0, 0.10 or greater, 0.20 or greater, 0.30 or greater, 0.40 or greater, 0.50 or greater, or 0.60 or greater, and may be 1.00 or less, 0.90 or less, 0.80 or less, or 0.70 or less. In addition, x may be 0 or greater, 0.10 or greater, 0.20 or greater, 0.30 or greater, 0.40 or greater, or 0.50 or greater, and may be 1.00 or less, 0.90 or less, 0.80 or less, 0.70 or less, 0.60 or less, or 0.50 or less. Further, y may be 0 or greater, 0.10 or greater, or 0.20 or greater, and may be 1.00 or less, 0.90 or less, 0.80 or less, 0.70 or less, 0.60 or less, 0.50 or less, 0.40 or less, 0.30 or less, or 0.20 or less. Moreover, z may be 0 or greater, 0.10 or greater, 0.20 or greater, or 0.30 or greater, and may be 1.00 or less, 0.90 or less, 0.80 or less, 0.70 or less, 0.60 or less, 0.50 or less, 0.40 or less, or 0.30 or less. The element M has a small contribution towards charging-discharging. In this regard, in the above chemical composition, by having p+q+r less than 0.17, a high charging-discharging capacity is easily ensured. p+q+r may be 0.15 or less, 0.13 or less, 0.11 or less, 0.09 or less, 0.07 or less, 0.06 or less, 0.05 or less, or 0.04 or less. By including the element M, a P2-type structure and an O2-type structure is easily stabilized. In this regard, in the above chemical composition, p+q+r is 0 or greater, and may be greater than 0, 0.01 or greater, 0.02 or greater, or 0.03 or greater. The composition of O is approximately 2, but may be variable without being limited to exactly 2.0.

### 1.2 Step S2

In the step S2, at least a portion of Na in the Na-containing transition metal oxide obtained by the step S1 is substituted with Li by ion exchange to obtain a Li-containing transition metal oxide having an O2-type structure. In the step S2, at least a portion of Na in the Na-containing transition metal oxide can be substituted with Li, for example, by ion exchange using a lithium salt. For example, a portion of Na can be substituted with Li by ion exchange by mixing a Na-containing transition metal oxide having a P2-type structure with a lithium salt and then heating to the temperature of the melting point of the lithium salt or higher to melt the lithium salt. The lithium salt, for example, may be a lithium halide. The lithium halide is preferably at least one of lithium chloride, lithium bromide, and lithium iodide. Alternatively, the lithium salt may be lithium nitrate. Alternatively, the lithium salt may be a mixed salt of a lithium halide and lithium nitrate.

In the step S2, doping with an element M may be carried out in the case of the above ion exchange. For example, the oxide can be doped with an element M by heating and melting a salt comprising the element M and then bringing the salt into contact with the above Na-containing transition metal oxide. Examples of the salt comprising the element M include halides of the element M. In the step S2, the Na-containing transition metal oxide may have at least a portion of Na subjected to ion exchange with Li and doped with the element M by bringing the above

Na-containing transition metal oxide into contact with a salt comprising Li and the element M. When a salt comprising Li and the element M (a mixed salt of a lithium salt and the element M or a composite salt of Li and the element M) is used, the melting point of the salt can be lowered, compared to when a lithium salt or a salt of the element M is used independently. Particularly, when a salt comprising at least one of Al and Ga as the element M and Li is used, the melting point tends to be lowered significantly. Specifically, the temperature required for melting is lowered, and the above ion exchange with Li and doping with the element M can be carried out at a low temperature. The mixing ratio of the lithium salt to the salt of the element M is not particularly limited. Specific examples of the salt comprising Li and the element M include salts comprising Li, the element M, and a halogen (mixed salts of a lithium halide and a halide of the element M or composite halides of Li and the element M).

The temperature (for example, heating temperature when the lithium salt is brought into contact with the Na-containing transition metal oxide and then heated and melted for ion exchange) in the step S2, for example, may be 600° C. or lower, 500° C. or lower, 400° C. or lower, 350° C. or lower, 300° C. or lower, 280° C. or lower, 250° C. or lower, 230° C. or lower, 200° C. or lower, 170° C. or lower, or 150° C. or lower, and may be room temperature or higher, or 100° C. or higher. When the temperature is too high, an O3-type structure, which is a stable phase, is easily generated instead of an O2-type structure. Melting the lithium salt may be heating at the melting point of the lithium salt or higher, as described above. The time (for example, heating time when the lithium salt is brought into contact with the Na-containing transition metal oxide and then heated and melted for ion exchange) in the step S2 may be adjusted so that a large portion of Na in the Na-containing transition metal oxide particles is substituted with Li. From the viewpoint of ensuring sufficient time to melt the lithium salt, the time in the step S2, for example, may be 10 min or more or 60 min or more, and may be 12 h or less or 6 h or less. The atmosphere in the step S2 is not particularly limited, and for example, may be an oxygen-containing atmosphere such as an ambient air atmosphere or an inert gas atmosphere. After ion exchange, the Li-containing transition metal oxide having an O2-type structure may be subjected to some post-treatment, such as washing.

In the step S2, the O2-type Li-containing transition metal oxide obtained by ion exchange may comprise at least one element selected from Mn, Ni, and Co; Li; and O as constituent elements. Particularly, when the constituent elements include at least one element selected from Mn, Ni, and Co; Li; and O, especially when the constituent elements include Li, Mn, Ni, Co, and O, higher performance is easily ensured. The O2-type Li-containing transition metal oxide obtained by ion exchange can comprise Na as a constituent element due to the manufacturing steps described above. In addition, the O2-type Li-containing transition metal oxide obtained by ion exchange can comprise the element M described above. Further, the O2-type Li-containing transition metal oxide obtained by ion exchange can comprise additional impurity elements. The chemical composition of the O2-type Li-containing transition metal oxide obtained by ion exchange in the step S2 may be represented by LiₐNa_{b}Mnₓ₋ₚNi_{y-q}Co_{z-r}M_{p+q+r}O₂ (where 0<a≤0.70; 0≤b≤0.20; x+y+z=1; and 0≤p+q+r<0.17, and element M is at least one selected from B, Mg, Al, K, Ca, Ti, V, Cr, Fc, Cu, Zn, Ga, Ge, Sr, Y, Zr, Nb, Mo, and W). In the chemical composition, a is greater than 0 and may be 0.10 or greater, 0.20 or greater, 0.30 or greater, 0.40 or greater, 0.50 or greater, or 0.60 or greater. b is 0 or greater and may be greater than 0, and is 0.20 or less and may be 0.15 or less, 0.10 or less, 0.05 or less, 0.04 or less, 0.03 or less, 0.02 or less, or 0.01 or less. The values of x, y, z, p, q, and r and the composition of O may be the same as those exemplified as the chemical composition of the Na-containing transition metal oxide obtained in the step S1, and the descriptions thereof are omitted here. Note that in the above chemical composition, when the valence of the element M is +n, the relationship 3.0≤4(x−p)+2(y−q)+3(z−r)+n(p+q+r)≤3.5 may be satisfied. This is intended for a range in which the total valence of metals in the Li-containing transition metal oxide is near the value of 3.33 (charge-neutral when a is 0.67). As described above, the Li-containing transition metal oxide having an O2-type structure is synthesized from the Na-containing transition metal oxide having a P2-type structure. At this time, charge neutrality in a range where the Na composition is 0.5 or greater and 1.0 or less corresponds to satisfying the above relationship.

### 1.3 Step S3

The Li-containing transition metal oxide having an O2-type structure can be obtained through the above steps S1 and S2. However, according to the findings of the present inventors, it is difficult to obtain a sufficient amount of Li contained in the Li-containing transition metal oxide only through the above steps S1 and S2. For example, in the above ion exchange, the molar ratio of Li (the above a) in the Li-containing transition metal oxide is only 0.70 or less, and the potential of reversible capacity of an O2-type positive electrode active material cannot be fully extracted.

In the step S3, the Li-containing transition metal oxide obtained by the above step S2 is further doped with Li in a step separate from the ion exchange, whereby the molar ratio of Li (the above a) in the Li-containing transition metal oxide can be increased to greater than 0.70. In the step S3, for example, it is preferable that the Li-containing transition metal oxide be further doped with Li in a step separate from the above ion exchange without applying a driving force by voltage (that is, charging/discharging of a battery). For example, the Li-containing transition metal oxide may be doped with Li by bringing a Li doping source into contact with the Li-containing transition metal oxide.

Specifically, in the step S3, it is preferable that the Li-containing transition metal oxide be further doped with Li in a step separate from ion exchange by bringing a reducing solution comprising Li ions into contact with the Li-containing transition metal oxide. A “reducing solution” means a solution having reducing properties, and for example, may be a solution comprising an electrophile. The reducing solution, for example, may be obtained by dissolving an electrophile and a Li source in a solvent. Various organic solvents capable of dissolving an electrophile and a Li source can be adopted as the solvent.

The solvent constituting a reducing solution, for example, may be an ether. In other words, the reducing solution may comprise an ether. The ether, for example, is preferably at least one selected from tetrahydrofuran (such as tetrahydrofuran and 2-methyltetrahydrofuran), dialkyl ether (such as dibutyl ether), and alkylene glycol dialkyl ether (such as dimethoxyethane), which may have substituents.

Various substances that dissolve in the above solvent can be adopted for the electrophile. The electrophile contained in the reducing solution, for example, may be an aromatic compound. In other words, the reducing solution may comprise an aromatic compound. When the aromatic compound comprises a plurality of benzene rings, electron density within the structure decreases, electrons inserted into the structure of the aromatic compound are stabilized, and a higher effect can be expected. When the aromatic compound comprises an electron-withdrawing group as a substituent, electrons are attracted by the electron-withdrawing group, electron density within a benzene ring decreases, electrons inserted within the structure of the aromatic compound are stabilized, and a higher effect can be expected. An “electron-withdrawing group” refers to a group having a relatively high electronegativity and comprising a halogen, oxygen, and/or nitrogen. Specifically, the clectron-withdrawing group may be at least one selected from a halogen group, a carbonyl group, and a nitro group. The aromatic compound as an electrophile, for example, is preferably at least one selected from biphenyl (for example, biphenyl and 2-methylbiphenyl) that may have a substituent, fluorenone (for example, 9-fluorenone) that may have a substituent, naphthalene (for example, naphthalene, fluoronaphthalene, bromonaphthalene, and nitronaphthalene) that may have a substituent, anthracene (for example, anthracene and 9-bromoanthracene) that may have a substituent, tetracene that may have a substituent, pentacene that may have a substituent, and tetraphenylcyclopentadienone that may have a substituent.

For the Li source, various substances that generate Li ions when dissolved in the above solvent can be adopted. The Li source may be metallic lithium or may be a Li compound.

The concentrations of the electrophile and the Li ions contained in the reducing solution may be appropriately determined in accordance with the target doping amount. According to the findings of the present inventors, the larger the amount of Li ions contained in the reducing solution relative to the amount of the Li-containing transition metal oxide in contact with the reducing solution, the larger the doping amount of Li relative to the Li-containing transition metal oxide tends to be. For example, when the above Li-containing transition metal oxide is immersed in a reducing solution, the molar ratio (Li ions/Li-containing transition metal oxide) of Li ions contained in the reducing solution to Li-containing transition metal oxide immersed in the reducing solution may be 0.1 or greater, 0.2 or greater, 0.3 or greater, 0.4 or greater, 0.5 or greater, 0.6 or greater, 0.7 or greater, or 0.8 or greater, and may be 2.0 or less, 1.5 or less, 1.0 or less, 0.9 or less, 0.8 or less, 0.7 or less, 0.6 or less, 0.5 or less, 0.4 or less, 0.3 or less, or 0.2 or less. Particularly, when the molar ratio (Li ions/Li-containing transition metal oxide) is 0.4 or greater and 0.8 or less, a positive electrode active material having excellent performance is easily obtained. The molar ratio (electrophile/Li ions) of the electrophile to the Li ions contained in the reducing solution is not particularly limited, and for example, may be 0.5 or more and 2.0 or less, 0.7 or more and 1.5 or less, or 0.9 or more and 1.1 or less.

In the step S3, the Li-containing transition metal oxide can be further doped with Li, for example, simply by bringing the Li-containing transition metal oxide into contact with the reducing solution described above. The contact state between the reducing solution and the Li-containing transition metal oxide is not particularly limited. For example, the Li-containing transition metal oxide may be immersed in the reducing solution. Alternatively, the reducing solution may be sprayed onto the Li-containing transition metal oxide. The temperature during contact is also not particularly limited, and heating may or may not be used. Stirring may be carried out after the Li-containing transition metal oxide is immersed in the reducing solution. The time in which the Li-containing transition metal oxide is brought into contact with the reducing solution is not particularly limited, and may be appropriately determined in accordance with the target doping amount. The contact time, for example, may be 1 min or more, 30 min or more, or 1 h or more, and may be 48 h or less, 40 h or less, or 30 h or less. In the step S3, after the above Li doping, a washing step and a drying step may be appropriately carried out. The impurity amount (amount of impurities from the reducing solution) contained in the positive electrode active material can be controlled by the washing step and the drying step.

### 2. Positive Electrode Active Material

From the foregoing, a positive electrode active material having an O2-type structure (O2-type Li-containing transition metal oxide) having a larger Li amount than in the prior art and a high capacity can be manufactured through the steps S1 to S3. The positive electrode active material obtained via the steps S1 to S3, for example, may have the following characteristics.

### 2.1 Crystal Structure

The positive electrode active material has at least an O2-type structure (belonging to space group P63mc). The positive electrode active material may have a crystal structure other than an O2-type structure, in addition to having an O2-type structure. Examples of the crystal structure other than an O2-type structure include a T #2-type structure (belonging to space group Cmca) and an O6-type structure (belonging to space group R-3m and differing from an O3-type structure belonging to the same space group R-3m), which are formed when Li is deintercalated from an O2-type structure. The positive electrode active material may have an O2-type structure as the main phase or may have a crystal structure other than an O2-type structure as the main phase, but having an O2-type structure as the main phase is particularly preferable. The positive electrode active material may have a crystal structure for the main phase that changes depending on the charging-discharging state.

### 2.2 Chemical Composition

The positive electrode active material may comprise at least one element selected from Mn, Ni, and Co; Li; and O as constituent elements. Particularly, when the constituent elements include Mn; at least one of Ni and Co; Li; and O, especially when the constituent elements include at least Li, Mn, Ni, Co, and O, higher performance is easily ensured. However, in the positive electrode active material, for example, Li can be almost completely released by charging, and the molar concentration of Li can approach a limit near 0. The positive electrode active material can comprise Na as a constituent element due to the manufacturing steps described above. In addition, the positive electrode active material can comprise the above element M. Further, the positive electrode active material can comprise additional impurity elements.

The chemical composition of the positive electrode active material having an O2-type structure may be represented by LiₐNa_{b}Mnₓ₋ₚNi_{y-q}Co_{z-r}M_{p+q+r}₂ (where 0.70<a≤1.40; 0≤b≤0.20; x+y+2=1; and 0≤p+q+r<0.17, and M is at least one element selected from B, Mg, Al, K, Ca, Ti, V, Cr, Fc, Cu, Zn, Ga, Ge, Sr, Y, Zr, Nb, Mo, and W). In the chemical composition, a is greater than 0.70 and may be 0.80 or greater, 0.90 or greater, 1.00 or greater, greater than 1.00, 1.05 or greater, or 1.10 or greater, and is 1.40 or less and may be 1.35 or less, 1.30 or less, 1.25 or less, 1.23 or less, 1.21 or less, or 1.20 or less. The values of b, x, y, z, p, q, and r and the composition of O may be the same as those exemplified as the chemical composition of the Li-containing transition metal oxide obtained in the step S2, and the descriptions thereof are omitted here.

### 2.3 Shape

The positive electrode active material may be particulate. The positive electrode active material particle may be a solid particle, may be a hollow particle, or may be one having voids. The positive electrode active material particle may be a primary particle, or may be a secondary particle of a plurality of agglomerated primary particles. The average particle diameter (D50) of the positive electrode active material particles, for example, may be 1 nm or more, 5 nm or more, or 10 nm or more, and may be 500 μm or less, 100 μm or less, 50 μm or less, or 30 ƒm or less. Note that the average particle diameter D50 referred to in the present application is the 50% cumulative particle diameter (median diameter) in a volume-based particle size distribution determined by a laser diffraction/scattering method.

### 2.4 Others

The positive electrode active material can comprise components resulting from the above manufacturing steps as impurities. For example, the positive electrode active material may comprise a component derived from the reducing solution.

For example, the positive electrode active material may comprise 1 ppm or more (based on mass) of an aromatic compound. The positive electrode active material may comprise 1 ppm or more and 1000 ppm or less, 5 ppm or more and 800 ppm or less, or 50 ppm or more and 600 ppm or less of an aromatic compound. When the positive electrode active material comprises 1 ppm or more of an aromatic compound, the following effects can be expected. Specifically, as the aromatic compound decomposes accompanying the charging-discharging of the battery, a satisfactory SEI is formed on the surface of the positive electrode active material, and an advantageous effect on battery reactions can be expected. In addition, the aromatic compound functions as a lubricant on the surface of the positive electrode active material, and an effect of suppressing cracks in the positive electrode active material can be expected during the manufacture (pressing) of a battery or when a volume change occurs in the positive electrode active material. Further, an effect of increasing the filling rate of the positive electrode active material layer during the manufacture (pressing) of the battery can be expected.

The aromatic compound that can be contained in the positive electrode active material, as described above, may comprise a plurality of benzene rings, and/or may comprise an electron-withdrawing group. Specific examples of the aromatic compound that can be contained in the positive electrode active material include at least one selected from biphenyl (for example, biphenyl and 2-methylbiphenyl) that may have a substituent, fluorenone (for example, 9-fluorenone) that may have a substituent, naphthalene (for example, naphthalene, fluoronaphthalene, bromonaphthalene, and nitronaphthalene) that may have a substituent, anthracene (for example, anthracene, 9-bromoanthracene) that may have a substituent, tetracene that may have a substituent, pentacene that may have a substituent, and tetraphenylcyclopentadienone that may have a substituent.

The positive electrode active material may comprise 1 ppm or more (based on mass) of an ether. The positive electrode active material may comprise 1 ppm or more and 1000 ppm or less, 10 ppm or more and 900 ppm or less, or 30 ppm or more and 800 ppm or less of an ether. When the positive electrode active material comprises 1 ppm or more of an ether, the following effects can be expected. Specifically, as the ether decomposes accompanying the charging-discharging of a battery, a satisfactory SEI is formed on the surface of the positive electrode active material, and an advantageous effect on battery reactions can be expected. In addition, the ether functions as a lubricant on the surface of the positive electrode active material, and an effect of suppressing cracks in the positive electrode active material can be expected during the manufacture (pressing) of a battery or when a volume change occurs in the positive electrode active material. Further, an effect of increasing the filling rate of the positive electrode active material layer during the manufacture (pressing) of the battery can be expected.

The ether that can be contained in the positive electrode active material, as described above, may be at least one selected from tetrahydrofuran (such as tetrahydrofuran and 2-methyltetrahydrofuran), dialkyl ether (such as dibutyl ether), and alkylene glycol dialkyl ether (such as dimethoxyethane), which may have substituents.

### 2.5 Variation of Positive Electrode Active Material

The positive electrode active material according to a variation has an O2-type structure and comprises 1 ppm or more of an aromatic compound. The positive electrode active material may comprise 1 ppm or more and 1000 ppm or less, 5 ppm or more and 800 ppm or less, or 50 ppm or more and 600 ppm or less of an aromatic compound. When the positive electrode active material having an O2-type structure comprises 1 ppm or more of an aromatic compound, the effect of SEI formation and the lubricating effect, as described above, are easily exhibited. Such a positive electrode active material can be manufactured, for example, by bringing the aromatic compound described above into contact with the positive electrode active material having an O2-type structure.

### 3. Method for Manufacturing Lithium-Ion Battery

The positive electrode active material manufactured as described above is used as, for example, a positive electrode active material of a lithium-ion battery. A method for manufacturing a lithium-ion battery may comprise, for example, manufacturing the positive electrode active material by the above method for manufacturing of the present disclosure, using the positive electrode active material manufactured to obtain a positive electrode active material layer, and using the positive electrode active material layer to obtain a lithium-ion battery, as shown in FIG. 2. The method for manufacturing a lithium-ion battery of the present disclosure may be the same method as in the prior art except that subsequent to the manufacture of the positive electrode active material of the present disclosure above, the positive electrode active material is used to obtain a positive electrode active material layer, for example, as follows.
(1) The positive electrode active material of the present disclosure above is dispersed in a solvent to obtain a positive electrode layer slurry. The solvent used in this case is not particularly limited, and water and various organic solvents can be used. The positive electrode layer slurry is applied on a surface of a positive electrode current collector using a doctor blade and then dried, whereby a positive electrode active material layer is formed on the surface of the positive electrode current collector to obtain a positive electrode.
(2) A negative electrode active material is dispersed in a solvent to obtain a negative electrode layer slurry. The solvent used in this case is not particularly limited, and water and various organic solvents can be used. The negative electrode layer slurry is applied on a surface of a negative electrode current collector using a doctor blade and then dried, whereby a negative electrode active material layer is formed on the surface of the negative electrode current collector to obtain a negative electrode.
(3) Layers are laminated so that an electrolyte layer (solid electrolyte layer or separator) is interposed between the negative electrode and the positive electrode to obtain a laminated body comprising a negative electrode current collector, a negative electrode active material layer, an electrolyte layer, a positive electrode active material layer, and a positive electrode current collector in this order. Additional members such as terminals are attached to the laminated body as needed.
(4) The laminated body is housed in a battery case. In the case of an electrolytic solution battery, a secondary battery is obtained by filling an electrolytic solution into a battery case, immersing the laminated body in the electrolytic solution, and sealing the laminated body within the battery case. Note that in the case of the electrolytic solution battery, the electrolytic solution may be contained in the negative electrode active material layer, the separator, and the positive electrode active material layer in the above stage (3).

### 4. Lithium-Ion Battery

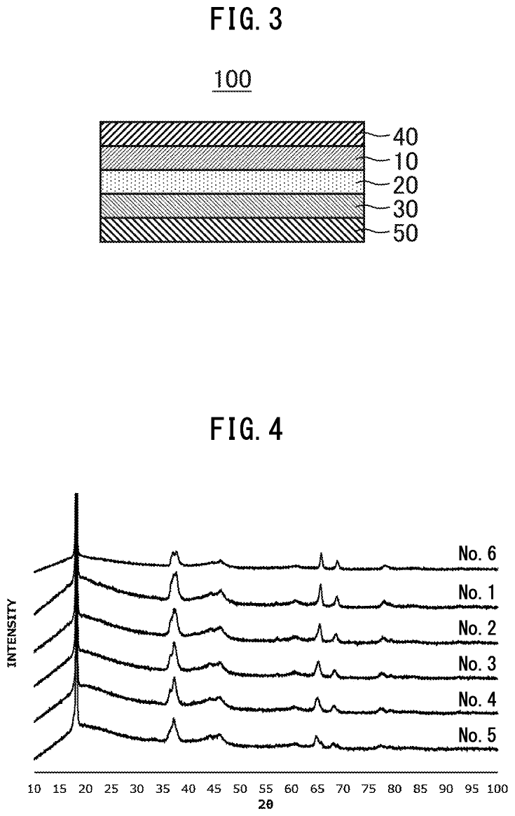

The technique of the present disclosure also has an aspect as a lithium-ion battery. For example, as shown in FIG. 3, the lithium-ion battery 100 according to one embodiment comprises a positive electrode active material layer 10, an electrolyte layer 20, and a negative electrode active material layer 30, wherein the positive electrode active material layer 10 comprises the above positive electrode active material of the present disclosure. As shown in FIG. 3, the lithium-ion battery 100 can be provided with a positive electrode current collector 40 and a negative electrode current collector 50. In the lithium-ion battery 100, features other than the positive electrode active material may be the same as in the prior art. For example, the features described in PTL 2 (Japanese Unexamined Patent Publication No. 2021-068556) can be adopted. Alternatively, the lithium-ion battery 100 may have the following features.

### 4.1 Positive Electrode Active Material Layer

The positive electrode active material layer 10 comprises at least the positive electrode active material according to the above embodiment, and may further optionally comprise an electrolyte, a conductive aid, and a binder. Further, the positive electrode active material layer 10 may additionally comprise various additives. The contents of the positive electrode active material, electrolyte, conductive aid, and binder in the positive electrode active material layer 10 need only to be appropriately determined in accordance with the target battery performance. For example, when the entire positive electrode active material layer 10 (entire solid content) is 100% by mass, the content of the positive electrode active material may be 40% by mass or greater, 50% by mass or greater, or 60% by mass or greater, and may be 100% by mass or less or 90% by mass or less. The shape of the positive electrode active material layer 10 is not particularly limited, and for example, may be a sheet-like positive electrode active material layer 10 having a substantially flat surface. The thickness of the positive electrode active material layer 10 is not particularly limited, and for example, may be 0.1 μm or more or 1 μm or more, and may be 2 mm or less or 1 mm or less.

### 4.1.1 Positive Electrode Active Material

The positive electrode active material is as described above. Specifically, the positive electrode active material comprises Li-containing oxide particles according to the above embodiment. As described above, the positive electrode active material may consist only of the above Li-containing oxide particles, or may comprise the above Li-containing oxide particles and another positive electrode active material (an additional positive electrode active material). From the viewpoint of further enhancing the effect according to the technique of the present disclosure, the ratio of the additional positive electrode active material to the entirety of the positive electrode active materials may be small. For example, when the entirety of the positive electrode active materials is 100% by mass, the content of the above Li-containing oxide particles is 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less.

Any known positive electrode active material for lithium-ion batteries can be adopted as the additional positive electrode active material. The additional positive electrode active material, for example, may be at least one selected from various lithium compounds other than the above Li-containing oxide, elemental sulfur, and sulfur compounds. The lithium compound as the additional positive electrode active material may be a Li-containing oxide comprising at least one element M, Li, and O. The element M, for example, may be at least one selected from Mn, Ni, Co, Al, Mg, Ca, Sc, V, Cr, Cu, Zn, Ga, Ge, Y, Zr, Sn, Sb, W, Pb, Bi, Fe, and Ti, or may be at least one selected from the group consisting of Mn, Ni, Co, Al, Fe, and Ti. More specifically, the Li-containing oxide as the additional positive electrode active material may be at least one selected from lithium cobaltate, lithium nickelate, lithium manganate, lithium nickel cobaltate, lithium nickel manganate, lithium cobalt manganate, lithium nickel-cobalt-manganese oxide (Li_{1±α}NiₓCo_{y}Mn_{z}O_{2±δ} (for example, 0<x<1, 0<y<1, 0<z<1, and x+y+z=1)), spinel-based lithium compounds (heteroelement-substituted Li—Mn spinels having a composition represented by Li₁₊ₓMn_{2-x-y}M_{y}O₄ (M is one or more selected from Al, Mg, Co, Fe, Ni, and Zn)), lithium nickel-cobalt-aluminum oxide (for example, Li_{1±α}NiₚCo_{q}AlᵣO_{2±δ} (for example, p+q+r=1)), lithium titanate, and lithium metal phosphate (such as LiMPO₄; M is one or more selected from Fe, Mn, Co, and Ni). Particularly, when the additional positive electrode active material at least comprises a Li-containing oxide comprising at least one of Ni, Co, and Mn; Li; and O as constituent elements, performance of the secondary battery is easily further enhanced. Alternatively, when the additional positive electrode active material at least comprises a Li-containing oxide comprising at least one of Ni, Co, and Al; Li; and O as constituent elements, performance of the secondary battery is easily further enhanced. The additional positive electrode active material may be of one type used alone, or may be of two or more types used in combination. The shape of the additional positive electrode active material needs only to be any of general shapes of positive electrode active materials of secondary batteries. The additional positive electrode active material, for example, may be particulate. The additional positive electrode active material may be solid, or may have voids therein, for example, may be porous or hollow. The additional positive electrode active material may be of primary particles, or may be of secondary particles of a plurality of agglomerated primary particles. The average particle diameter D50 of the additional positive electrode active material, for example, may be 1 nm or more, 5 nm or more, or 10 nm or more, and may be 500 μm or less, 100 μm or less, 50 μm or less, or 30 μm or less.

### 4.1.2 Protective Layer

A protective layer having ion-conducting properties may be formed on the surface of the positive electrode active material. Specifically, the positive electrode active material layer 10 may comprise a composite of the positive electrode active material and a protective layer. At least a portion of the surface of the positive electrode active material in the composite may be covered by the protective layer. As a result, for example, a reaction between the positive electrode active material and another battery material (such as the sulfide solid electrolyte described below) is easily suppressed. The protective layer having ion-conducting properties can include various ion-conducting compounds. The ion-conducting compound, for example, may be at least one selected from an ion-conducting oxide and an ion-conducting halide.

The ion-conducting oxide, for example, may comprise at least one selected from B, C, Al, Si, P, S, Ti, La, Zr, Nb, Mo, Zn, and W; Li; and O. The ion-conducting oxide may be an oxynitride comprising N. More specifically, the ion-conducting oxide may be at least one selected from Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄, LiPON, Li₂O—LaO₂, and Li₂O—ZnO₂. The ion-conducting oxide may have some elements substituted by various doping elements.

The ion-conducting halide, for example, may be at least one of various compounds exemplified as a halide solid electrolyte described below. The ion-conducting halide, for example, may comprise at least one element selected from the group consisting of Mg, Ca, Sr, Ba, Zn, Sn, Al, Sc, Ga, Bi, Sb, Zr, Hf, Ti, Ta, Nb, W, Y, Gd, Tb, and Sm, at least one halide selected from the group consisting of Cl, Br, I, and F, and Li. The ion-conducting halide may comprise at least one selected from the group consisting of Ti, Al, Gd, Ca, Zr, and Y, at least one selected from the group consisting of Cl, Br, I, and F, and Li. The ion-conducting halide may comprise at least one element selected from the group consisting of Ti and Al, at least one element selected from the group consisting of Cl, Br, I, and F, and Li. Further, the ion-conducting halide, for example, may be a composite halide of Li, Ti, Al, and F.

The coverage (area ratio) of the protective layer relative to the surface of the positive electrode active material, for example, may be 70% or greater, may be 80% or greater, or may be 90% or greater. The thickness of the protective layer, for example, may be 0.1 nm or more or 1 nm or more, and may be 100 nm or less or 20 nm or less.

### 4.1.3 Electrolyte

The positive electrode active material layer 10 can comprise an electrolyte. The electrolyte that can be contained in the positive electrode active material layer 10 may be a solid electrolyte, may be a liquid electrolyte, or may be a combination thereof.

### 4.1.3.1 Solid Electrolyte

The solid electrolyte needs only to be any known solid electrolyte for lithium-ion batteries. The solid electrolyte may be an inorganic solid electrolyte or an organic polymer electrolyte. Particularly, an inorganic solid electrolyte has excellent ion-conducting properties and heat resistance. Examples of the inorganic solid electrolyte include sulfide solid electrolytes, oxide solid electrolytes, and inorganic solid electrolytes having ion-binding properties. Among the inorganic solid electrolytes, the performance of sulfide solid electrolytes, particularly sulfide solid electrolytes comprising at least Li, S, and P as constituent elements, is high. Alternatively, among the inorganic solid electrolytes, the performance of solid electrolytes having ion-binding properties, particularly solid electrolytes comprising at least Li, Y, and a halogen (at least one of Cl, Br, I, and F) as constituent elements, is high. The solid electrolyte may be amorphous, or may be crystalline. The solid electrolyte may be particulate. The average particle diameter (D50) of the solid electrolyte, for example, may be 10 nm or more and 10 μm or less.

The oxide solid electrolyte may be one or more selected from lithium lanthanum zirconate, LiPON, Li₁₊ₓAlₓGe₂₋ₓ(PO₄)₃, Li—SiO-based glass, and Li—Al—S—O-based glass. When an oxide solid electrolyte and a liquid electrolyte are combined, ion-binding properties can be improved.

The sulfide solid electrolyte may be a glass-based sulfide solid electrolyte (sulfide glass), may be a glass-ceramic-based sulfide solid electrolyte, or may be a crystal-based sulfide solid electrolyte. The sulfide glass is amorphous. The sulfide glass may have a glass transition temperature (Tg). When the sulfide solid electrolyte has a crystal phase, examples of the crystal phase include Thio-LISICON-type crystal phase, LGPS-type crystal phase, and argyrodite-type crystal phase. The sulfide solid electrolyte may be particulate. The average particle size (D50) of the sulfide solid electrolyte, for example, may be 10 nm or more and 100 μm or less.

The sulfide solid electrolyte, for example, may contain Li element, an X element (X is at least one of P, As, Sb, Si, Ge, Sn, B, Al, Ga, and In), and S element. In addition, the sulfide solid electrolyte may further contain at least one of O element and a halogen element. Further, the sulfide solid electrolyte may contain S element as an anionic element main component.

The sulfide solid electrolyte, for example, may be at least one selected from Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and Z is any of Ge, Zn, and Ga), Li₂S—GeS₂, Li₂S—SiS₂—Li₃PO₄, and Li₂S—SiS₂—LiₓMO_{y} (where x and y are positive numbers, and M is any of P, Si, Ge, B, Al, Ga, and In).

The composition of the sulfide solid electrolyte is not particularly limited. Examples thereof include xLi₂S·(100−x)P₂S₅ (70≤x≤80) and yLiI·zLiBr·(100−y−z)(xLi₂S·(1−x)P₂S₅) (0.7≤x≤0.8, 0≤y≤30, and 0≤z≤30). Alternatively, the sulfide solid electrolyte may have a composition represented by general formula: Li₄₋ₓGe₁₋ₓPₓS₄ (0<x<1). In the general formula, at least a portion of Ge may be substituted with at least one of Sb, Si, Sn, B, Al, Ga, In, Ti, Zr, V, and Nb. In the above general formula, at least a portion of P may be substituted with at least one of Sb, Si, Sn, B, Al, Ga, In, Ti, Zr, V, and Nb. In the above general formula, a portion of Li may be substituted with at least one of Na, K, Mg, Ca, and Zn. In the above general formula, a portion of S may be substituted with a halogen (at least one of F, Cl, Br, and I). Alternatively, the sulfide solid electrolyte may have a composition represented by Li₇₋ₐPS₆₋ₐXₐ (X is at least one of Cl, Br, and I, and a is a number of 0 or greater and 2 or less). a may be 0 or may be greater than 0. In the latter case, a may be 0.1 or greater, may be 0.5 or greater, or may be 1 or greater. a may be 1.8 or less, or may be 1.5 or less.

The solid electrolyte having ion-bonding properties, for example, may comprise at least one clement selected from the group consisting of Mg, Ca, Sr, Ba, Zn, Sn, Al, Sc, Ga, Bi, Sb, Zr, Hf, Ti, Ta, Nb, W, Y, Gd, Tb, and Sm. These elements can generate cations in water. The ion-bonding solid electrolyte material, for example, may comprise at least one halogen element selected from the group consisting of Cl, Br, I, and F. These elements can generate anions in water. The solid electrolyte having ion-bonding properties may comprise at least one selected from the group consisting of Gd, Ca, Zr, and Y, at least one selected from the group consisting of Cl, Br, I, and F, and Li. The solid electrolyte having ion-bonding properties comprises Li and Y, and may comprise at least one selected from the group consisting of Cl, Br, I, and F. More specifically, the solid electrolyte having ion-bonding properties may comprise Li, Y, Cl, and Br, may comprise Li, Ca, Y, Gd, Cl, and Br, or may comprise Li, Zr, Y, and Cl. Even more specifically, the solid electrolyte having ion-bonding properties may be at least one of Li₃YBr₂Cl₄, Li_{2.8}Ca_{0.1}Y_{0.5}Gd_{0.5}Br₂Cl₄, and Li_{2.5}Y_{0.5}Zr_{0.5}Cl₆.

The solid electrolyte having ion-bonding properties may be a halide solid electrolyte. A halide solid electrolyte has excellent ion-conducting properties. The halide solid electrolyte may have a composition represented by, for example, formula (A):

Li_{α}M_{β}X_{γ} (A)

where α, β, and γ are each independently a value greater than 0, M is at least one selected from the group consisting of metal elements and semimetal elements other than Li, and X is at least one selected from the group consisting of Cl, Br, and I. Note that a “semimetal element” may be at least one selected from the group consisting of B, Si, Ge, As, Sb, and Te. Further, a “metal element” may include (i) all of the elements contained from Group 1 to Group 12 of the periodic table (excluding hydrogen) and (ii) all of the elements contained from Group 13 to Group 16 of the periodic table (excluding B, Si, Ge, As, Sb, Te, C, N, P, O, S, and Se). A metal clement can form an inorganic compound with halide ions and form cations.

In the formula (A), M may comprise Y (i.e., yttrium). A halide solid electrolyte comprising Y may have a composition represented by Li_{z}Me_{b}Y_{c}X₆ (where a+mb+3c=6, c>0, Me is at least one selected from the group consisting of metal elements and semimetal elements other than Li and Y, and m is the valence of Me). Me, for example, may be at least one selected from the group consisting of Mg, Ca, Sr, Ba, Zn, Sc, Al, Ga, Bi, Zr, Hf, Ti, Sn, Ta, and Nb.

The halide solid electrolyte may have a composition represented by formula (A1): Li_{6-3d}Y_{d}X₆. In the formula (A1), X is one or more elements selected from the group consisting of Cl, Br, and I. d may satisfy 0<d<2, and may be d=1. The halide solid electrolyte may have a composition represented by formula (A2): Li_{3-3δ}Y_{1+δ}Cl₆. In the formula (A2), δ may be 0<δ≤0.15. The halide solid electrolyte may have a composition represented by formula (A3): Li_{3-3δ}Y_{1+δ}Br₆. In the formula (A3), δ may be 0<δ≤0.25. The halide solid electrolyte may have a composition represented by formula (A4): Li_{3-3δ+a}Y_{1+δ-a}MeₐCl_{6-x-y}BrₓI_{y}. In the formula (A4), Me may be at least one selected from the group consisting of Mg, Ca, Sr, Ba, and Zn. In the formula (A4), for example, —1<δ<2, 0<a<3, 0<(3−3δ+a), 0<(1+δ−a), 0≤x≤6, 0≤y≤6, and (x+y)≤6 are satisfied. The halide solid electrolyte may have a composition represented by formula (A5): Li_{3-3δ}Y_{1+δ-a}MeₐCl_{6-x-y}BrₓI_{y}. In the formula (A5), Me may be at least one selected from the group consisting of Al, Sc, Ga, and Bi. In the formula (A5), the variables may satisfy −1<δ<1, 0<a<2, 0<(1+δ−a), 0≤x≤6, 0≤y≤6, and (x+y)≤6. The halide solid electrolyte may have a composition represented by formula (A6): Li_{3-3δ-a}Y_{1+δ-a}MeₐCl_{6-x-y}BrₓI_{y}. In the formula (A6), Me may be at least one selected from the group consisting of Zr, Hf, and Ti. In the formula (A6), the variables may satisfy −1−δ<1, 0<a<1.5, 0<(3−3δ−a), 0<(1+δ−a), 0≤x≤6, 0≤y≤6, and (x+y)≤6. The halide solid electrolyte may have a composition represented by formula (A7): Li_{3-3δ-2a}Y_{1+δ-a}Y_{1+δ-a}MeₐCl_{6-x-y}BrₓI_{y}. In the formula (A7), Me may be at least one selected from the group consisting of Ta and Nb. In the formula (A7), the variables may satisfy −1<δ<1, 0<a<1.2, 0<(3−3δ−2a), 0<(1+δ−a), 0≤x≤6, 0≤y≤6, and (x+y)≤6.

The solid electrolyte having ion-bonding properties may be a complex hydride solid electrolyte. The complex hydride solid electrolyte can be composed of Li ions and complex ions comprising H. The complex ion comprising H, for example, may comprise an element M comprising at least one of nonmetal elements, semimetal elements, and metal elements and H bonded to the element M. In the complex ion comprising H, an element M as a central element and H surrounding the element M may be bonded to each other via a covalent bond. The complex ion comprising H may be represented by (MₘHₙ)^{α-}. In this case, m can be any positive number, and n and a can take on any positive number depending on m and the valence of the element M. The element M needs only to be any nonmetal element or metal element that can form a complex ion. For example, the element M may comprise at least one of B, C, and N as a nonmetal element, or may comprise B. Further, for example, the element M may comprise at least one of Al, Ni, and Fe as a metal element. Particularly, when the complex ion comprises B or comprises C and B, higher ion-conducting properties is easily ensured. Specific examples of the complex ion comprising H include (CB₉H₁₀)⁻, (CB₁₁H₁₂)⁻, (B₁₀H₁₀)²⁻, (B₁₂H₁₂)²⁻, (BH₄)⁻, (NH₂)⁻, (AlH₄)⁻, and combinations thereof. Particularly, when (CB₉H₁₀)⁻, (CB₁₁H₁₂)⁻¹, or a combination thereof is used, higher ion-conducting properties is easily ensured. Specifically, the complex hydride solid electrolyte may comprise Li, C, B, and H.

### 4.1.3.2 Liquid Electrolyte

The liquid electrolyte (electrolytic solution) is a liquid comprising lithium ions as carrier ions. The electrolytic solution may be an aqueous electrolytic solution or a nonaqueous electrolytic solution. The composition of the electrolytic solution needs only to be the same as one known as a composition of an electrolytic solution for lithium-ion secondary batteries. The electrolytic solution may be water or a nonaqueous solvent dissolving a lithium salt. Examples of the nonaqueous solvent include various carbonate-based solvents. Examples of the lithium salt include lithium amide salts and LiPF6.

### 4.1.4 Conductive Aid

Examples of the conductive aid that can be contained in the positive electrode active material layer 10 include carbon materials such as vapor-grown carbon fiber (VGCF), acetylene black (AB), ketjen black (KB), carbon nanotube (CNT), and carbon nanofiber (CNF); and metal materials such as nickel, titanium, aluminum, and stainless steel. The conductive aid, for example, may be particulate or fibrous, and the size thereof is not particularly limited. The conductive aid may be of one type used alone, or may be of two or more types used in combination.

### 4.1.5 Binder

Examples of the binder that can be contained in the positive electrode active material layer 10 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 4.1.6 Others

The positive electrode active material layer 10 may comprise various additives, in addition to the above components, for example, a dispersant or a lubricant.

### 4.2 Electrolyte Layer

The electrolyte layer 20 is arranged between the positive electrode active material layer 10 and the negative electrode active material layer 30. The electrolyte layer 20 comprises at least an electrolyte. The electrolyte layer 20 may comprise at least one of a solid electrolyte and an electrolytic solution, and may further optionally comprise a binder. The contents of the electrolyte and the binder in the electrolyte layer 20 are not particularly limited. Alternatively, the electrolyte layer 20 may comprise a separator for retaining an electrolytic solution and preventing contact between the positive electrode active material layer 10 and the negative electrode active material layer 30. The thickness of the electrolyte layer 20 is not particularly limited, and for example, may be 0.1 μm or more or 1 μm or more, and may be 2 mm or less or 1 mm or less.

The electrolyte layer 20 may consist of one layer, or may consist of a plurality of layers. For example, the electrolyte layer 20 may be provided with a first layer arranged on the positive electrode active material layer 10 side and a second layer arranged on the negative electrode active material layer 30, wherein the first layer may comprise a first electrolyte and the second layer may comprise a second electrolyte. The first electrolyte and the second electrolyte may be of different types from each other. The first electrolyte and the second electrolyte may each be at least one selected from the above oxide solid electrolytes, sulfide solid electrolytes, and solid electrolytes having ion-bonding properties. For example, the first layer may comprise a solid electrolyte having ion-bonding properties, and the second layer may comprise at least one of a solid electrolyte having ion-bonding properties and a sulfide solid electrolyte.

The electrolyte contained in the electrolyte layer 20 needs only to be appropriately selected from among ones (solid electrolyte and/or liquid electrolyte) exemplified as an electrolyte that can be contained in the positive electrode active material layer 10 described above. The binder that can be contained in the electrolyte layer 20 needs only to be appropriately selected from among ones exemplified as a binder that can be contained in the positive electrode active material layer described above. The electrolyte and the binder may each be of one type used alone, or may be of two or more types used in combination. The separator may be any separator as long as the separator is normally used in lithium-ion batteries. Examples thereof include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose nonwoven fabric, resin nonwoven fabric, or glass-fiber nonwoven fabric.

### 4.3 Negative Electrode Active Material Layer

The negative electrode active material layer 30 comprises at least a negative electrode active material. The negative electrode active material layer 30 may optionally comprise an electrolyte, a conductive aid, a binder, and various additives. The content of each component in the negative electrode active material layer 30 needs only to be appropriately determined in accordance with the target battery performance. For example, when the entire solid content of the negative electrode active material layer 30 is 100% by mass, the content of the negative electrode active material may be 40% by mass or greater, 50% by mass or greater, 60% by mass or greater, or 70% by mass or greater, and may be 100% by mass or less, less than 100% by mass, 95% by mass or less, or 90% by mass or less. Alternatively, when the entire negative electrode active material layer 30 is 100% by volume, the negative electrode active material and optionally the electrolyte, conductive aid, and binder in total may be contained at 85% by volume or greater, 90% by volume or greater, or 95% by volume or greater, and the remaining portion may be voids or additional components. The shape of the negative electrode active material layer 30 is not particularly limited, and for example, may be a sheet having a substantially flat surface. The thickness of the negative electrode active material layer 30 is not particularly limited, and for example, may be 0.1 μm or more, 1 μm or more, 10 μm or more, or 30 μm or more, and may be 2 mm or less, 1 mm or less, 500 μm or less, or 100 μm or less.

Any known negative electrode active material for lithium-ion secondary batteries can be adopted as the negative electrode active material. Of known active materials, various materials having a low electric potential (charge/discharge potential) for storing and releasing lithium ions compared to the above positive electrode active material can be adopted. For example, silicon-based active materials such as Si, Si alloys, and silicon oxide; carbon-based active materials such as graphite and hard carbon; various oxide-based active materials such as lithium titanate; and metallic lithium and lithium alloys can be adopted. Among these, when the negative electrode active material layer 30 comprises Si as the negative electrode active material, performance of the lithium-ion battery 100 is easily enhanced. The negative electrode active material may be of one type used alone, or may be of two or more types used in combination. The shape of the negative electrode active material needs only to be any of general shapes of negative electrode active materials of secondary batteries. For example, the negative electrode active material may be particulate. The negative electrode active material particles may be primary particles, or may be secondary particles of a plurality of agglomerated primary particles. The average particle diameter (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 30 may consist of a sheet of negative electrode active material.

Examples of electrolytes that can be contained in the negative electrode active material layer 30 include the above solid electrolytes and electrolytic solutions, and combinations thereof. The conductive aid that can be contained in the negative electrode active material layer 30 needs only to be appropriately selected, for example, from among ones exemplified as a conductive aid that can be contained in the positive electrode active material layer described above. The binder that can be contained in the negative electrode active material layer 30 needs only to be appropriately selected, for example, from among ones exemplified as a binder that can be contained in the positive electrode active material layer described above. The electrolyte, the conductive aid, and the binder may each be of one type used alone, or may be of two or more types used in combination.

### 4.4 Positive Electrode Current Collector

As shown in FIG. 3, the lithium-ion battery 100 may be provided with a positive electrode current collector 40 in contact with the positive electrode active material layer 10. Any general positive electrode current collector for secondary batteries can be adopted as the positive electrode current collector 40. The positive electrode current collector 40 may have at least one shape selected from foil-like, plate-like, mesh-like, punched metal-like, and a foam. The positive electrode current collector 40 may be composed of a metal foil or a metal mesh. Particularly, a metal foil has excellent handleability. The positive electrode current collector 40 may consist of a plurality of foils. Examples of metals constituting the positive electrode current collector 40 include at least one selected from Cu, Ni, Cr, Au, Pt, Ag, Al, Fe, Ti, Zn, Co, V, Mg, Pb, Ge, In, Sn, Zr, and stainless steel. Particularly, from the viewpoint of retaining oxidation resistance, the positive electrode current collector 40 may comprise Al. The positive electrode current collector 40 may have on the surface thereof some coating layer for the purpose of adjusting resistance. For example, the positive electrode current collector 40 may have a carbon coating layer. The positive electrode current collector 40 may be a metal foil or substrate plated or vapor-deposited with a metal described above. When the positive electrode current collector 40 consists of a plurality of metal foils, there may be some layer between the plurality of metal foils. The thickness of the positive electrode current collector 40 is not particularly limited, and for example, may be 0.1 μm or more or 1 μm or more, and may be 1 mm or less or 100 μm or less.

### 4.5 Negative Electrode Current Collector

As shown in FIG. 3, the lithium-ion battery 100 may comprise a negative electrode current collector 50 in contact with the negative electrode active material layer 30. Any general negative electrode current collector for secondary batteries can be adopted as the negative electrode current collector 50. The negative electrode current collector 50 may be foil-like, plate-like, mesh-like, punched metal-like, or a foam. The negative electrode current collector 50 may be a metal foil or a metal mesh, and alternatively, may be a carbon sheet. Particularly, a metal foil has excellent handleability. The negative electrode current collector 50 may consist of a plurality of foils or sheets. Metals constituting the negative electrode current collector 50 include at least one selected from Cu, Ni, Cr, Au, Pt, Ag, Al, Fe, Ti, Zn, Co, V, Mg, Pb, Ge, In, Sn, Zr, and stainless steel. Particularly, from the viewpoint of ensuring reduction resistance and the viewpoint of making alloying with lithium difficult, the negative electrode current collector 50 may comprise at least one metal selected from Cu, Ni, and stainless steel. The negative electrode current collector 50 may have on the surface thereof some coating layer for the purpose of adjusting resistance. For example, the negative electrode current collector 50 may have a carbon coating layer. The negative electrode current collector 50 may be an aluminum foil having a carbon coating layer. The negative electrode current collector 50 may be a metal foil or a substrate plated or vapor-deposited with a metal described above. When the negative electrode current collector 50 consists of a plurality of metal foils, there may be some layer between the plurality of metal foils. The thickness of the negative electrode current collector 50 is not particularly limited, and for example, may be 0.1 μm or more or 1 μm or more, and may be 1 mm or less or 100 μm or less.

### 4.6 Additional Configurations

The lithium-ion battery 100, in addition to the above configuration, may be provided with any general configuration as a secondary battery, for example, tabs or terminals. The lithium-ion battery 100 may be the above configuration housed inside an outer packaging. Any known outer packaging can be adopted as the outer packing of the battery. In addition, a plurality of batteries 100 may be optionally connected electrically and optionally stacked to form a battery pack. In this case, the battery pack may be housed inside a known battery case. Examples of shapes of the lithium-ion battery 100 can include coin-type, laminate-type, cylindrical, and rectangular. The lithium-ion battery 100 may be a secondary battery.

### EXAMPLES

From the foregoing, one embodiment of the method for manufacturing a positive electrode active material of the present disclosure has been described. However, it is possible to modify the method for manufacturing a positive electrode active material of the present disclosure in various ways other than the above embodiments without departing from the spirit thereof. Hereinafter, the technique of the present disclosure will be further described in detail with reference to the Examples. However, the technique of the present disclosure is not limited to the following Examples.

### 1. Production of Positive Electrode Active Material

### 1.1 Coprecipitation Synthesis of Transition Metal Source

MnSO₄·5H₂O, NiSO₄·6H₂O, and CoSO₄·7H₂O were weighed to a target compositional ratio and dissolved in distilled water to a concentration of 1.2 mol/L to obtain a first solution. In a separate container, Na₂CO₃ was dissolved in distilled water to a concentration of 1.2 mol/L to obtain a second solution. The first solution and the second solution, each at 500 mL, were then added dropwise at a rate of about 4 mL/min into a reactor already loaded with 1000 mL of pure water. Upon the completion of the dropwise addition, the mixture was stirred at a stirring rate of 150 rpm at room temperature for 1 h. The precipitate was washed with pure water and subjected to solid-liquid separation with a centrifugal separator. The resulting precipitate was dried overnight at 120° C. and crushed with a mortar, fine particles were removed by gasflow classification, and mixed salt particles (transition metal source) comprising Mn, Ni, and Co were obtained.

### 1.2 Mixing of Transition Metal Source and Na Source (Na Coating)

Na₂CO₃ and distilled water were weighed to 1150 g/L and then stirred to complete dissolution using a stirrer to produce a Na₂CO₃ aqueous solution. The above mixed salt particles were mixed into the Na₂CO₃ aqueous solution to obtain a slurry. The Na₂CO₃ and the above mixed salt particles were mixed so as to have a composition of Na_{0.7}Mn_{0.5}Ni_{0.2}Co_{0.3}O₂ after drying. The obtained slurry was dried by spray drying. Specifically, using a spray drying apparatus DL410, under the conditions of a slurry feed rate of 30 mL/min, an inlet temperature of 200° C., a circulating gas volume of 0.8 m³/min, and a spraying gas pressure of 0.3 MPa, surfaces of the above mixed salt particles were coated with Na₂CO₃ to obtain precursor particles.

### 1.3 Firing of Precursor Particles

An alumina crucible was used for firing of the precursor particles in an electric furnace in an ambient air atmosphere (humidity of 50% or greater). Specifically, the precursor particles were subjected to a “first heating step”, a “pre-firing step”, a “second heating step”, a “main firing step”, and an “in-furnace cooling step”, as indicated in Table 1 below. The fired product was then removed from the electric furnace at 250° C. and crushed in a mortar in a dry atmosphere having a dew point of −30° C. or lower to obtain a Na-containing transition metal oxide (Na_{0.7}Mn_{0.5}Ni_{0.2}Co_{0.3}O₂) having a P2-type structure.

TABLE 1

| | Starting | Ending | | Heating or |
|---|---|---|---|---|
| | temperature | temperature | Time | cooling rate |
| Step | (° C.) | (° C.) | (min) | (° C./min) |
| First beating step | 25 | 600 | 115 | 5 |
| Pre-firing step | 600 | 600 | 360 | 0 |
| Second heating step | 600 | 900 | 100 | 3 |
| Main firing step | 900 | 900 | 60 | 0 |
| In-furnace cooling step | 900 | 250 | 130 | 5 |

### 1.4 Ion Exchange

LiNO₃ and LiCl were weighed to a molar ratio of 50:50 and mixed with the above Na-containing transition metal oxide at a molar ratio 10 times the minimum Li amount required for ion exchange to obtain a mixture. An alumina crucible was then used to fire the mixture at 280° C. for 1 h in an ambient air atmosphere (humidity of 50% or greater). Salt remaining after firing was washed away with pure water and the fired mixture was subjected to solid-liquid separation by vacuum filtration. The resulting precipitate was dried overnight at 120° C. to obtain a Li-containing transition metal oxide having an O2-type structure.

### 1.5 Li Doping (Nos. 1 to 5)

Biphenyl was mixed and dissolved in tetrahydrofuran (THF) to 1 mol/L in a glove box (Ar atmosphere) to obtain a biphenyl solution. Li foil at the same mole as the biphenyl was further added in the biphenyl solution and stirred for 2 h to obtain a reducing solution comprising 1 mol/L of Li ions. The above Li-containing transition metal oxide was added, immersed, and stirred in the obtained reducing solution for 24 h. After stirring, the Li-containing transition metal oxide was washed with THF and subjected to solid-liquid separation by vacuum filtration. The resulting precipitate was dried overnight at 120° C. to obtain a positive electrode active material (Li-containing transition metal oxide further doped with Li). By changing the molar ratio (Li ions/Li-containing transition metal oxide) of Li ions contained in the reducing solution to Li-containing transition metal oxide immersed in the reducing solution, as indicated in Table 2 below, a positive electrode active material of Nos. 1 to 5 was obtained.

### 1.6 No. 6

The Li-containing transition metal oxide after ion exchange was used as a positive electrode active material as-is without Li doping.

### 2. Determination of Chemical Composition and Crystal Structure of Positive Electrode Active Material

The chemical composition of the positive electrode active material in each of Nos. 1 to 6 were determined by ICP analysis. Nos. 1 to 6 all had a chemical composition represented by Li_{X}Mn_{0.5}Ni_{0.2}Co_{0.3}O₂, i.e., the compositional ratios of the transition metals were the same but the compositional ratio of Li varied. Further, X-ray diffraction measurements were carried out on the positive electrode active material in each of Nos. 1 to 6, and the crystal structure was identified. X-diffraction pattern of each No. is shown in Table 4. As shown in Table 4, the positive electrode active materials of Nos. 1 to 6 all had an O2-type crystal structure.

### 3. Production of Coin Cell

The above positive electrode active material, acetylene black (AB) as a conductive material, and PVdF as a binder were weighed so as to have a mass ratio of positive electrode active material:AB:PVdF=85:10:5, and dispersed and mixed in N-methyl-2-pyrrolidene to obtain a positive electrode slurry. The positive electrode slurry was applied on an Al foil and dried overnight at 120° C. to obtain a positive electrode. The resulting positive electrode, an electrolytic solution (TDDK-217, manufactured by Daikin), and a metallic Li foil as a negative electrode were used to produce a coin cell (CR2032).

### 4. Evaluation of Coin Cell

The coin cell was charged at a voltage range of 2 to 4.8 V at a rate of 0.1 C (1 C=240 mA/g) in an isothermal chamber maintained at 25° C., and the initial charging capacity was measured.

5. Evaluation results

Table 2 below shows the “molar ratio (Li ions/Li-containing transition metal oxide) of Li ions contained in the reducing solution to Li-containing transition metal oxide immersed in the reducing solution” in the Li doping step, the Li amount (value of X in Li_{X}Mn_{0.5}Ni_{0.2}Co_{0.3}O₂) determined by ICP analysis, and the initial charging capacity of the coin cell for each of Nos. 1 to 6.

TABLE 2

| | | | Initial charging capacity |
|---|---|---|---|
| No. | Molar ratio | X | (mAh/g) |
| 1 | 0.1 | 0.71 | 182.7 |
| 2 | 0.3 | 0.92 | 218.4 |
| 3 | 0.4 | 1.01 | 235.6 |
| 4 | 0.6 | 1.21 | 228.5 |
| 5 | 0.8 | 1.40 | 219.2 |
| 6 | no doping | 0.62 | 144.5 |

As shown in Table 2, the value of X for the positive electrode active material not doped with Li of No. 6 after ion exchange fell below 0.70, whereas the value of X for Nos. 1 to 5 doped with Li after ion exchange in a step separate from the ion exchange exceeded 0.70. As a result, the initial charging capacities of the coin cells of Nos. 1 to 5 were significantly increased compared to that of the coin cell of No. 6. Specifically, it was found that the potential of capacity as an O2-type positive electrode active material could be extracted by further doping Li after ion exchange in a step separate from the ion exchange.

### 6. Regarding Case where Type of Reducing Solution was Changed

### 6.1 Production of Positive Electrode Active Material

### 6.1.1 Examples 1 to 20

A Li-containing transition metal oxide having an O2-type structure was obtained in the same manner as Nos. 1 to 6 above. An “electrophile” indicated in Table 3 below was then mixed in a “solvent” indicated in Table 3 in a glove box (Ar atmosphere) to 1 mol/L and dissolved to obtain an electrophile solution. Li foil at the same mole as the electrophile was further added to the electrophilic solution and stirred for 2 h to obtain a reducing solution comprising 1 mol/L of Li ions. The above Li-containing transition metal oxide was added, immersed, and stirred for 24 h in the obtained reducing solution. After stirring, the Li-containing transition metal oxide was washed with a solvent and subjected to solid-liquid separation by vacuum filtration. The resulting precipitate was dried overnight at 120° C. to obtain a positive electrode active material (Li-containing transition metal oxide further doped with Li). By changing the molar ratio (Li ions/Li-containing transition metal oxide) of Li ions contained in the reducing solution to Li-containing transition metal oxide immersed in the reducing solution as indicated in Table 3 below, a positive electrode active material of each of Examples 1 to 20 was obtained.

### 6.1.2 Comparative Example

A Li-containing transition metal oxide having an O2-type structure was obtained in the same manner as in above No. 6, and then used as-is as a positive electrode active material according to Comparative Example without Li doping by a reducing solution.

### 6.2 Determination of Chemical Composition and Crystal Structure of Positive Electrode Active Material

The chemical composition of the positive electrode active material in each of Examples 1 to 20 and Comparative Example was determined by ICP analysis. The positive electrode active materials according to Examples 1 to 20 and Comparative Examples all had a chemical composition represented by Li_{X}Mn_{0.5}Ni_{0.2}Co_{0.3}O₂, i.e., the compositional ratios of the transition metals were the same but the compositional ratio of Li varied. Further, X-ray diffraction measurements were carried out on the positive electrode active material of each of Examples 1 to 20 and Comparative Example, and the crystal structure was identified, where all had an O2-type crystal structure.

### 6.3 Production and Evaluation of Coin Cell

Using the positive electrode active material of each of Examples 1 to 20 and Comparative Example, a coin cell was produced in the same manner as above, and the initial charging capacity was measured in the same manner as above.

### 6.4 Evaluation Results

Table 3 below shows the types of solvent and electrophile constituting the reducing solution, the electric potential (V vs. Li/Li+) of the reducing solution, the molar ratio (Li ions/Li-containing transition metal oxide) of Li ions contained in the reducing solution to Li-containing transition metal oxide immersed in the reducing solution, the Li amount (value of X in Li_{X}Mn_{0.5}Ni_{0.2}co_{0.3}O₂) of the positive electrode active material determined by ICP analysis, and the initial charging capacity of the cell coin for each of Examples 1 to 20 and Comparative Example.

TABLE 3

| | Reducing solution | | Solution potential | Molar | | Initial charging |
|---|---|---|---|---|---|---|
| | Solvent | Electrophile | [V vs. Li/Li+] | ratio | X | capacity [mAh/g] |
| Comp. Example 1 | no doping | | | | 0.62 | 144.5 |
| Example 1 | THF | BP | 0.45 | 0.1 | 0.71 | 182.7 |
| Example 2 | THF | BP | 0.45 | 0.3 | 0.92 | 218.4 |
| Example 3 | THF | BP | 0.45 | 0.4 | 1.01 | 235.6 |
| Example 4 | THF | BP | 0.45 | 0.6 | 1.21 | 228.5 |
| Example 5 | THF | BP | 0.45 | 0.8 | 1.40 | 219.2 |
| Example 6 | THF | 2-MBP | 0.34 | 0.4 | 1.01 | 231.4 |
| Example 7 | THF | NP | 0.54 | 0.4 | 1.02 | 238.1 |
| Example 8 | THF | FNP | 0.59 | 0.4 | 1.02 | 229.9 |
| Example 9 | THF | BNP | 0.74 | 0.4 | 1.01 | 228.4 |
| Example 10 | THF | AT | 1.10 | 0.4 | 1.00 | 240.8 |
| Example 11 | THF | 9-BAT | 1.40 | 0.4 | 1.00 | 231.3 |
| Example 12 | THF | 9-FL | 2.10 | 0.1 | 0.72 | 187.7 |
| Example 13 | THF | 9-FL | 2.10 | 0.3 | 0.92 | 227.8 |
| Example 14 | THF | 9-FL | 2.10 | 0.4 | 0.98 | 240.6 |
| Example 15 | THF | 9-FL | 2.10 | 0.6 | 0.98 | 240.9 |
| Example 16 | THF | 9-FL | 2.10 | 0.8 | 0.98 | 241.2 |
| Example 17 | THF | NNP | 2.80 | 0.4 | 0.81 | 189.3 |
| Example 18 | THF | TPCPD | 3.30 | 0.4 | 0.66 | 153.9 |
| Example 19 | 2-MTHF | BP | 0.45 | 0.4 | 1.01 | 232.3 |
| Example 20 | DBE | BP | 0.45 | 0.4 | 1.02 | 234.9 |

In Table 3 above, tetrahydrofuran is written as “THF”; 2-methyltetrahydrofuran is written as “2-MTHF”; dibutyl ether is written as “DBE”; biphenyl is written as “BP”; 2-methylbiphenyl is written as “2-MBP”; naphthalene is written as “NP”; fluoronaphthalene is written as “FNP”; bromonaphthalene is written as “BNP”; anthracene is written as “AT”; 9-bromoanthracene is written as “9-BAT”; 9-fluorenone is written as “9-FL”; nitronaphthalene is written as “NNP”, and tetraphenylcyclopentadienone is written as “TPCPD”.

As shown in Table 3, the value of X for the positive electrode active material (Comparative Example) not doped with Li after ion exchange fell below 0.70, whereas the value of X for the positive electrode active materials (Examples 1 to 20) further doped with Li using a predetermined reducing solution after ion exchange in a step separate from the ion exchange exceeded 0.70. As a result, the initial charging capacities of the coin cells according to Examples 1 to 20 were significantly increased compared to the coin cell according to the Comparative Example. Specifically, it was found that the potential of capacity as an O2-type positive electrode active material could be extracted by further doping Li using a reducing solution after ion exchange in a step separate from the ion exchange, regardless of the type of the solvent or electrophile in the reducing solution.

The capacity tended to be larger when 9-fluorenone was used as the electrophile in the reducing solution than when biphenyl was used. When biphenyl was used as the electrophile, reduction potential (electric potential of reducing solution) was as low as 0.45 V. As the Li doping amount increases in response to the increase in the molar ratio (Li ions/Li-containing transition metal oxide) of Li ions contained in the reducing solution to Li-containing transition metal oxide immersed in the reducing solution, reduction property of the reducing solution increases, and thus it is considered that a structural change in the positive electrode active material is likely to occur. On the other hand, when 9-fluorenone was used as the electrophile, reduction potential was 2.10 V, which matches the OCV when the composition X of Li in the positive electrode active material=1.0. Thus, even when the molar ratio (Li ions/Li-containing transition metal oxide) of Li ions contained in the reducing solution to Li-containing transition metal oxide immersed in the reducing solution is high, it is considered that a structural change in the active material is not likely to occur.

### 7. Regarding Impurities Contained in Positive Electrode Active Material

When producing a positive electrode active material, various changes were made to washing conditions (washing time) and drying conditions (drying temperature and drying time) after Li doping to control the amount of impurities remaining in the positive electrode active material, in order to obtain the positive electrode active materials according to Examples 21 to 27. The same reducing solution as in Example 3 (solvent: THF, electrophile: biphenyl, molar ratio: 0.4) was used. The amount (ppm, based on mass) of impurities remaining in the positive electrode active material of each of Examples 21 to 27 was measured by GC-MS. A coin cell was produced in the same manner as above using the positive electrode active material of each of Examples 21 to 27, and initial charging capacity was measured. Table 4 below shows the Li amount (value of X in Li_{X}Mn_{0.5}Ni_{0.2}Co_{0.3}O₂) of the positive electrode active material determined by ICP analysis, the impurity amount (THE amount and biphenyl amount) contained in the positive electrode active material determined by GC-MS measurement, and the initial charging capacity of coin cell.

TABLE 4

| | | | | Initial |
|---|---|---|---|---|
| | | THF amount | Biphenyl amount | charging capacity |
| | X | [ppm] | [ppm] | [mAh/g] |
| Example 21 | 1.01 | 1 | 8 | 235.3 |
| Example 22 | 1.01 | 30 | 8 | 235.6 |
| Example 23 | 1.01 | 260 | 8 | 232.0 |
| Example 24 | 1.01 | 750 | 8 | 220.1 |
| Example 25 | 1.01 | 30 | 1 | 235.1 |
| Example 26 | 1.01 | 30 | 60 | 234.7 |
| Example 27 | 1.01 | 30 | 570 | 218.4 |

As shown in Table 4, it was found that when a Li-containing transition metal oxide having an O2-type structure was doped with Li with a reducing solution, impurities derived from the reducing solution remained in the positive electrode active material after Li doping. Specifically, the positive electrode active material of the present disclosure, for example, can comprise 1 ppm or more of an aromatic compound and/or can comprise 1 ppm or more of an ether. A positive electrode active material comprising an aromatic compound or an ether as an impurity can be expected to have an effect of forming a satisfactory SEI due to decomposition of the impurity during charging-discharging and a lubricating effect from the impurity.

### 8. Regarding Chemical Composition of Li-Containing Transition Metal Oxide Constituting Positive Electrode Active Material

Except that the blending ratios of MnSO₄·5H₂O, NiSO₄·6H₂O, and CoSO₄·7H₂O in “Coprecipitation synthesis of transition metal source” were changed and the firing temperature in “Firing of precursor particles” was changed to a temperature at which a P2-type structure could be generated, a Li-containing transition metal oxide having an O2-type structure was produced in the same manner as in No. 3 above. The obtained Li-containing transition metal oxide was doped with Li using a reducing solution in the same manner as in No. 3 above to obtain the positive electrode active materials according to Examples 22 and 23. Each of the obtained positive electrode active materials was used to produce a coin cell in the same manner as in No. 3 above, and the initial charging capacity was measured. Table 5 below shows the types of solvent and electrophile constituting the reducing solution, the transition metal composition (Mn:Ni:Co) and the Li amount (value of X in LixMeO₂) of positive electrode active material determined by ICP analysis, and the initial charging capacity of coin cell.

TABLE 5

| | Compositional ratio of | | | | |
|---|---|---|---|---|---|
| | transition metals | | | | |
| | contained in positive | Reducing | | | Initial |
| | electrode active | solution | | | charging |
| | material (molar ratio) | Sol- | Elec- | | capacity |
| | Mn:Ni:Co | vent | trophile | X | [mAh/g] |
| Example 28 | 4:2:4 | THF | BP | 1.01 | 241.7 |
| Example 29 | 3:3:4 | THF | BP | 1.01 | 236.5 |

As shown in Table 5, it was found that even when the compositional ratio of the transition metals constituting the positive electrode active material was changed, the compositional ratio X of Li constituting the positive electrode active material can be increased to 1.0 or greater due to Li doping by the reducing solution, and as a result, a high capacity could be ensured.

Although the above Examples exemplify a case where a precursor comprising Na and a transition metal was obtained via a coprecipitation method and spray drying, the production conditions of the precursor are not limited thereto. Further, although the above Examples exemplify a case where a precursor and a P2-type Na-containing transition metal oxide having a specific chemical composition were produced and used to manufacture an O2-type positive electrode active material, the chemical composition of the O2-type positive electrode active material is not limited thereto. Furthermore, although the above Examples exemplify a case where a specific reducing solution was used for doping with Li, the reducing solution is not limited thereto. Moreover, it is considered that various conditions can be changed as along as Li can be further doped after ion exchange in a step separate from the ion exchange.

### REFERENCE SIGNS LIST

10 positive electrode active material layer
20 electrolyte layer
30 negative electrode active material layer
40 positive electrode current collector
50 negative electrode current collector
100 lithium-ion battery

1. A method for manufacturing a positive electrode active material, the method comprising:
obtaining a Na-containing transition metal oxide having a P2-type structure,
substituting at least a portion of Na in the Na-containing transition metal oxide with Li by ion exchange to obtain a Li-containing transition metal oxide having an O2-type structure, and
further doping the Li-containing transition metal oxide with Li in a step separate from the ion exchange.

2. The method according to claim 1, wherein
the Li-containing transition metal oxide is further doped with Li in a step separate from the ion exchange by bringing a reducing solution comprising Li ions in contact with the Li-containing transition metal oxide.

3. The method according to claim 2, wherein
the reducing solution comprises an aromatic compound.

4. The method according to claim 3, wherein
the aromatic compound comprises a plurality of benzene rings.

5. The method according to claim 3, wherein
the aromatic compound comprises an electron-withdrawing group.

6. The method according to claim 2, wherein
the reducing solution comprises an ether.

7. A method for manufacturing a lithium-ion battery, the method comprising
manufacturing a positive electrode active material by the method according to claim 1,
using the positive electrode active material manufactured to obtain a positive electrode active material layer, and
using the positive electrode active material layer to obtain a lithium-ion battery.

8. A positive electrode active material
having an O2-type structure and
having a chemical composition represented by LiₐNa_{b}Mnₓ₋ₚNi_{y-q}Co_{z-r}M_{p+q+r}O₂, wherein 0.70<a≤1.40; 0≤b≤0.20; x+y+z=1; and 0≤p+q+r<0.17, and M is at least one element selected from B, Mg, Al, K, Ca, Ti, V, Cr, Fe, Cu, Zn, Ga, Ge, Sr, Y, Zr, Nb, Mo, and W.

9. The positive electrode active material according to claim 8, wherein
the positive electrode active material comprises 1 ppm or more of an aromatic compound.

10. The positive electrode active material according to claim 9, wherein
the aromatic compound comprises a plurality of benzene rings.

11. The positive electrode active material according to claim 9, wherein
the aromatic compound comprises an electron-withdrawing group.

12. The positive electrode active material according to claim 8, wherein
the positive electrode active material comprises 1 ppm or more of an ether.

13. A positive electrode active material,
having an O2-type structure and
comprising 1 ppm or more of an aromatic compound.

14. A lithium-ion battery comprising a positive electrode active material layer, an electrolyte layer, and a negative electrode active material layer, wherein
the positive electrode active material layer comprises the positive electrode active material according to claim 8.
